(19) United States
(12) Patent Application Publication
(10) Pub. No.: US 2003/0016838 A1
(43) Pub. Date: Jan. 23, 2003

(54) Optical microphone systems and method of operating same

(75) Inventors: Alexander Paritsky, Modi'in (IL); Alexander Kots, Ashdod (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Phone-Or Ltd

(21) Appl. No.: 10/187,364

(22) Filed: Jul. 2, 2002

(30) Foreign Application Priority Data
Jul. 23, 2001 (IL) 144497

(51) Int. Cl. H04R 25/00

(52) U.S. Cl. 381/172

(57) ABSTRACT

An optical microphone which comprises a source of light connectable to a power source for illuminating an acoustically sensitive membrane; a photo detector having an output for transforming light reflected by the membrane into electrical signals proportional to the intensity of the reflected light; and a circuit for measuring the level of signals at the output of the photodetector for controlling the current fed to the source of light by the power source so that the current is low when the output signals of the photodetector are lower than a defined value, and the current is high when the output signals of the photodetector are higher than the defined value.

This Application claims the benefit of priority from IL Patent Application No. 144497, filed Jul. 23, 2001.

### FIELD OF THE INVENTION

The present invention relates to optical microphones, and more particularly, to optical microphone systems and a method for decreasing the power consumption of an optical microphone.

### BACKGROUND OF THE INVENTION

An optical microphone is a device that consists of a source of light, such as an LED or laser, for producing light energy, and an acoustically sensitive membrane that reflects the light energy in the direction of a photo detector. The output signal of the photodetector is the output of the optical microphone.

The sensitivity of an optical microphone is a function of the current supplied to its light source. The higher this current, the higher the microphone's sensitivity At the same time, the higher current requires a greater supply of energy, which is not always available under different working conditions, and is especially problematic in the case of cellular telephones, wherein the entire energy of the device is supplied from a. small battery having a relatively small energy capacity

### SUMMARY OF THE INVENTION

It is therefore a broad object of the present invention to provide an optical microphone system having small power consumption, controlled sensitivity and background noise suppression capability.

It is a further object of the present invention to provide a method for decreasing the power consumption of an optical microphone.

The invention therefore provides an optical microphone, comprising a source of light connectable to a power source for illuminating an acoustically sensitive membrane; a photo detector having an output for transforming light reflected by the membrane into electrical signals proportional to the intensity of the reflected light, and a circuit for measuring the level of signals at the output of the photodetector for controlling the current fed to the source of light by the power source so that the current is low when the output signals of the photodetector are lower than a defined value, and the current is high when the output signals of the photodetector are higher than the defined value.

The invention further provides a method for decreasing the power consumption of an optical microphone, the method comprising generating light by means of a power source feeding a source of light; illuminating a reflecting membrane responsive to acoustical signals; receiving light signals reflected by the membrane and transforming the light signals into electrical signals; measuring the electrical signals, and controlling the current applied to the source of light from the power source as a function of the level of the electrical signals.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram of the optical microphone of the present invention;

FIG. 2 is a more detailed schematic block diagram of an optical microphone including a light source current controller;

FIG. 3 is a detailed schematic block diagram of a further embodiment of an optical microphone including a controlled signal level; and

FIG. 4 is a schematic block diagram of a still further embodiment of an optical microphone having a pulse generator.

### DETAILED DESCRIPTION

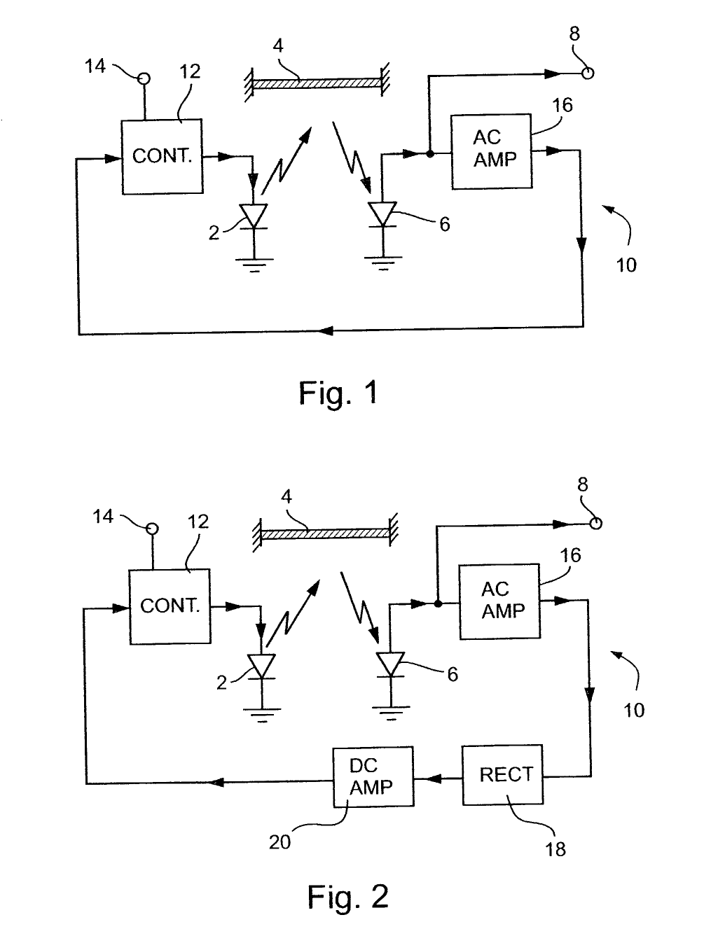

FIG. 1 illustrates a basic block diagram of an optical microphone system according to the present invention. A source of light 2, e.g., a light-emitting diode (LED), a laser, or any other source of light, emits light towards an acoustically sensitive membrane 4. The light reflected by the membrane is received by photodetector 6, converted into corresponding electrical signals, and fed to the output 8 of the microphone system. The output 8 from photodetector 6 is also connected to a circuit 10 for measuring the levels of the output signals. Circuit 10 leads to a current controller 12, which controls the light source current from an input 14 in accordance with the output signal levels.

The levels of the output signals, corresponding to the levels of the incoming acoustical signals, are measured by circuit 10, which measures the microphone's output signal level and accordingly produces its own output signals. The measurement results are fed to controller 12, for controlling the current feeding the light source 2 in two ways: if the output signal level is low, the value of the current feeding the light source 2 is low; if the output signal level is high, the value of the light source feeding current is high. Hence, the controller 12 transforms the output signal from circuit 10 into current, to feed the source of right 2, in two distinct states: a stand-by state, wherein a very small current feeds the source of light 2, and a working state, wherein normal current is fed to the source of light 2.

The change of currents fed to the light source 2 results in a change in the microphone's sensitivity and a change in the microphone's power consumption resulting from the input acoustical, signal. In the stand-by state, the power consumption is very small, and the microphone's sensitivity is very low. In the working state, power consumption is nominal and the microphone's sensitivity is normal.

When someone talks adjacent to the microphone, the acoustical signal on membrane 4, the signal at output 8, and the output signal from circuit 10 are all high, and controller 12 is in the working state, i.e., it feeds normal current to the source of light 2; thus, the sensitivity of the microphone is normal. When the speaker pauses or listens to what is said by the person to whom he is speaking, the acoustical signals on membrane 4, the output signal 8, and the output signal from circuit 10 are low, and controller 12 is in the stand-by state, i.e., it feeds low current to the source of light 2, and the sensitivity of the microphone is low. Consequently, when the microphone's sensitivity is normal, the current consumption is normal, and upon a pause in speech, the microphone's sensitivity is very low and the current consumption is also low.

Naturally, a low sensitivity microphone suppresses all background noises. Hence, if the speaker is not talking but only listening, the power consumption is decreased to a minimum value and the background noise is suppressed. When the speaker starts to talk, the microphone's power consumption is normal and its sensitivity returns to normal

FIG. 2 is a more detailed block diagram of an optical microphone according to the present invention, showing that circuit 10 of FIG. 1 is composed of an alternating current (AC) amplifier 16, a rectifier 18 and a direct current (DC) amplifier 20.

Amplifier 16 amplifies the output signal from photodetector 6 to increase the sensitivity of the regulation. Rectifier 18 transforms the alternating signals into a direct voltage proportional to the amplitude of the signals, and the DC voltage is amplified by DC amplifier 20. The output signal from amplifier 20 corresponds to the microphone output signal level at output 8. Controller 12 receives the signals and produces corresponding currents to feed the source of light 2. The regulation of current is thus correlated with the output signal from amplifier 16. If the level of this automatic control. Output signals from amplifier 16 are fed to both controller 12 and to attenuator 22 through line 24. Attenuator 22 may alternatively be connected at other places in the circuit, e.g., between photodetector 6 and amplifier 16, or between rectifier 18 and amplifier 20. In all cases, the attenuator's function is to compensate for the changes in signal levels caused by changes in the sensitivity of the optical microphone

Specifically, when the acoustical signal level at membrane 4 and at the output of amplifier 20 decreases due to the regulation of the current level from controller 12 to the source of light 2, the signals at attenuator 22 win similarly be decreased, and there will not be a further attenuation of the signals to rectifier 18.

As mentioned above, at the stand-by state, the current of the light source 2 is very small and the sensitivity of the microphone is very low; tl 1us, the speaker's voice has to be sufficiently strong to enable the switching of the microphone from the standby state to the working state. In order to ameliorate this problem, as shown in FIG. 4, a pulse generator 26 may be connected ill circuit between the feedback lines 24 and controller 12. In the stand-by state, pulse generator 26 produces pulse signals which ate fed through controller 12 to the source of light 2. The current of a pulse from generator 26 may be sufficiently high to assist the switching of the microphone into the normal working state by means of the speaker's voice. Thus, the sensitivity of the microphone during the application of a pulse is not as high as at the normal state, but is sufficiently high to switch the microphone into the normal state.

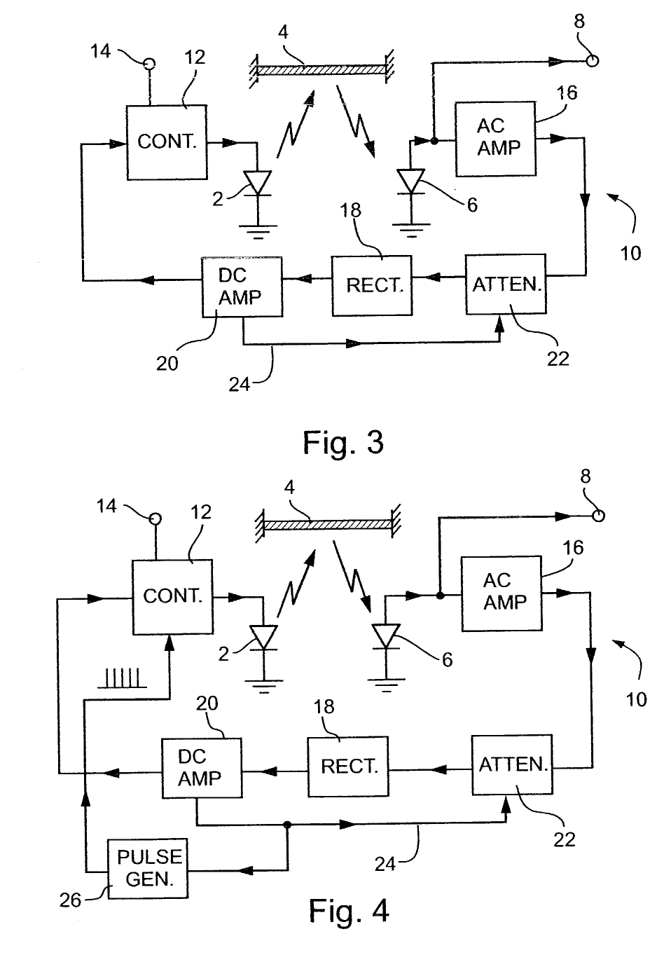

At the same time, because the feeding of the light source 2 is made by pulses, the common power consumption of the microphone is the same as, or even less than, that described above with regard to FIGS. 1 to 3.

It will he evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scone of the invention being indicated by the appended claims rather than by the foregoing description, and all changes which come within the meaning and range of equivalency of the claims are therefore intended to be embraced therein.

What is claimed is:

1. An optical microphone system, comprising;
a source of light connectable to a power source, for illuminating an acoustically sensitive membrane;
a photodetector having an output, for transforming light reflected by the membrane into electrical signals proportional to the intensity of the reflected light;
a circuit, for measuring the level of signals at the output of said photodetector; and
a controller, for controlling the current fed to the source of light by said power source;
the arrangement being such that the current applied to said source of light is low when the output signals of said photodetector are lower than a predetermined value, and the current is high when the output signals of the photo detector are higher than said predetermined value.

2. The optical microphone system as claimed in claim 1, wherein said circuit for measuring the level of signals at the output of said photo detector comprises an AC amplifier leading to a rectifier connected to a DC amplifier.

3. The optical microphone system as claimed in claim 2, further comprising an attenuator connected between said circuit and said controller, for measuring the level of signals at the output of said photodetector, said attenuator also being connected to the output of said DC amplifier to form a feedback line.

4. The optical microphone system as claimed in claim 3, further comprising a pulse generator connected between said controller and said feedback line.

5. A method for decreasing the power consumption of an optical microphone, said method comprising:
generating light by means of a power source feeding a source of light;
illuminating a reflecting membrane responsive to acoustical signals;
receiving light signals reflected by said membrane and transforming the light signals into electrical signals;
measuring said electrical signals; and
controlling the current applied to said source of light from said power source as a function of the level of said electrical signals.

6. The method as claimed in claim 5, wherein the current supplied by said power source to said source of light is low when the level of said electrical signals is lower than a predetermined level, and said current is normal when the level of said electrical signals is higher than said predetermined level.

7. The method as claimed in claim 5, further comprising:
generating pulses by a pulse generator; and
feeding said pulses to said source of light when the level of said electrical signals is lower than a predetermined level.

8. The method as claimed in claim 5, wherein the current supplied by said power source to said source of light is, in a first state, low current and, in a second state, high current, the sensitivity of said microphone being a function of said first and second states.

9. An optical microphone system as claimed in claim 1, substantially as hereinbefore described and with reference to the accompanying drawings.

10. A method as claimed in claim 5, for decreasing the power consumption of an optical microphone, substantially as hereinbefore described and with reference to the accompanying drawings.
